(19) United States
(12) Patent Application Publication
(10) Pub. No.: US 2026/0204086 A1
(43) Pub. Date: Jul. 16, 2026

(54) SYSTEMS AND METHODS FOR CLASSIFYING BLOOD CELLS

(71) Applicant: Siemens Healthcare Diagnostics Inc., Tarrytown, NY (US)

(72) Inventors: Slobodan Ilic, Munich (DE); Anna Bodonhelyi, Garching bei München (DE); Thomas Engel, Aalen (DE); Gaby Marquardt, Hausen (DE); Agnieszka Maria Tomczak, München (DE)

(21) Appl. No.: 19/130,947

(22) PCT Filed: Nov. 17, 2023
(86) PCT No.: PCT/US2023/080249

§ 371 Date: May 18, 2025

Related U.S. Application Data
(60) Provisional application No. 63/384,358, filed on Nov. 18, 2022.
(60) Provisional application No. 63/386,761, filed on Dec. 9, 2022.

(51) Int. Cl. G06V 20/69; G06V 10/40; G06V 10/764; G06V 10/82

(52) U.S. Cl. CPC G06V 20/698; G06V 10/40; G06V 10/764; G06V 10/82; G06V 20/693

(57) ABSTRACT

In some embodiments, a method of classifying components of a blood sample is provided that includes digitally staining an image of a blood sample using a trained machine-learning model so as to generate a digitally-stained image; extracting one or more intermediate features generated by the trained machine-learning model during digital staining of the image; providing the one or more extracted intermediate features to a trained multi-class classifier; and employing the trained multi-class classifier to classify at least one component within the blood sample based on the one or more extracted intermediate features. Numerous other embodiments are provided.

### FIELD

The present application relates to classifying biological samples, and more specifically to classifying blood cells.

### BACKGROUND

Analysis of blood cells using microscopy is a fundamental tool in clinical diagnosis and medical research. Chemically staining blood cells enhances the contrast between cells and their sub-components, thereby facilitating the identification and differentiation of various cell types and morphologies. For example, features necessary to classify a pathological erythrocyte or granulation of the cytoplasm of an eosinophil leukocyte may not be visible in an unstained image but clearly identifiable in a chemically stained image.

Despite the effectiveness of conventional chemical staining methods, they often require multi-step procedures that can be time-consuming and prone to error. Additionally, chemical staining methods employ chemical reagents that may be costly, pose health risks to laboratory personnel, and require proper disposal.

Therefore, there is a need for improved methods and systems for classifying bloods cells without requiring the use of chemical staining.

### SUMMARY

In some embodiments, a method of classifying components of a blood sample is provided that includes digitally staining an image of a blood sample using a trained machine-learning model so as to generate a digitally-stained image; extracting one or more intermediate features generated by the trained machine-learning model during digital staining of the image; providing the one or more extracted intermediate features to a trained multi-class classifier; and employing the trained multi-class classifier to classify at least one component within the blood sample based on the one or more extracted intermediate features.

In some embodiments, a machine-learning-based digital staining and classification system is provided that includes a processor; a memory coupled to the processor, the memory including a trained machine-learning model and a multi-class classifier coupled to the trained machine-learning model; and computer program instructions stored in the memory that, when executed by the processor, cause the processor to digitally stain an image of a blood sample using the trained machine-learning model so as to generate a digitally-stained image; extract one or more intermediate features generated by the trained machine-learning model during digital staining of the image; provide the one or more extracted intermediate features to the trained multi-class classifier; and employ the trained multi-class classifier to classify at least one component within the blood sample based on the one or more extracted intermediate features.

Other features and aspects of the present invention will become more fully apparent from the following detailed description, the appended claims, and the accompanying drawings.

### BRIEF DESCRIPTION OF THE DRAWINGS

FIG. 1A illustrates an example flow diagram of a method of classifying components of a blood sample in accordance with embodiments provided herein.

FIG. 1B illustrates an example computer in which the method of FIG. 1A may be implemented in accordance with one or more embodiments.

FIGS. 2A and 2B illustrate example embodiments of a first digital staining and classification system (FIG. 2A) and a second digital staining and classification system (FIG. 2B) each having a GAN generator, a GAN discriminator, and a multi-class classifier in accordance with embodiments provided herein.

FIGS. 3A-3C illustrate category-wise digital staining metrics for leukocytes for four models in accordance with embodiments provided herein.

FIG. 3D illustrates accuracy in image quality results for leukocytes between stained, unstained, and the three best performing models in accordance with embodiments provided herein.

FIG. 4 illustrates a flowchart of a method of classifying components of a blood sample in accordance with one or more embodiments.

### DETAILED DESCRIPTION

Independent of the grammatical term usage, individuals with male, female or other gender identities are included within the term.

Embodiments provided herein include methods and systems for digitally staining and classifying one or more components of a blood sample such as the size, shape, hemoglobin distribution, inclusions, etc., of erythrocytes (red blood cells), size, shape, granules, morphology, type, etc., of leukocytes (white blood cells), and the like.

In some embodiments, a trained machine-learning (ML) model is employed to digitally stain an image of a blood sample. One or more intermediate features (e.g., one or more feature vectors) generated by the trained ML model (during digital staining of the image) are extracted and provided to a trained multi-class classifier. The trained multi-class classifier may then classify one or more components within the blood sample based on the one or more extracted intermediate features. As used herein, “intermediate features” refer to features, such as feature vectors, generated within intermediate layers of an ML model, such as intermediate layers of an ML model used during formation of a digitally-stained image. Intermediate features are not typically visible in a final digitally-stained image output from the ML model.

In some embodiments, the one or more intermediate features extracted from the trained ML model may include a feature vector extracted from a last layer of a bottleneck of the generator (e.g., the layers of a GAN generator between the encoder and decoder layers) or from a decoder layer of the generator. Further, in one or more embodiments, the feature vector may be added to a feature vector of the multi-class classifier. Other intermediate features may be employed. As stated, the one or more extracted intermediate features may not be directly visible in the digitally-stained image (although intermediate features may influence the digitally-stained image output by the generator).

In one or more embodiments, the trained ML model employed for digital staining may include a generator of a generative adversarial network (GAN). In this manner, multi-output learning may be combined with style transfer based on GANs. Other machine-learning models may be employed.

Example blood sample images that may be employed include blood samples smears measured using bright and/or dark field microscopy, captured under reflected and/or transmitted illumination conditions, computed microscopy as generated from a series of images of Fourier imaging modes such as Fourier ptychography images, differential-interference-contrast microscopy, interference-reflection microscopy, phase-contrast microscopy, Hoffman-modulation-contrast microscopy, or a similar process. Other image types may be employed.

Through use of a trained ML model (for digital staining) and a multi-class classifier, features not readily visible but present in the original image may be employed to classify components of a blood sample without the use of chemical staining. That is, features allowing correct classification were found to be present in unstained images. For example, in two datasets analyzed, all features needed for classification were present in unstained images of healthy blood samples. Further, in some embodiments, use of extracted intermediate features (from a GAN generator) by a multi-class classifier improved classification performance, and class information improved generated image quality in terms of accuracy, F1 score, mean square error (MSE), and structural similarity index measure (SSIM).

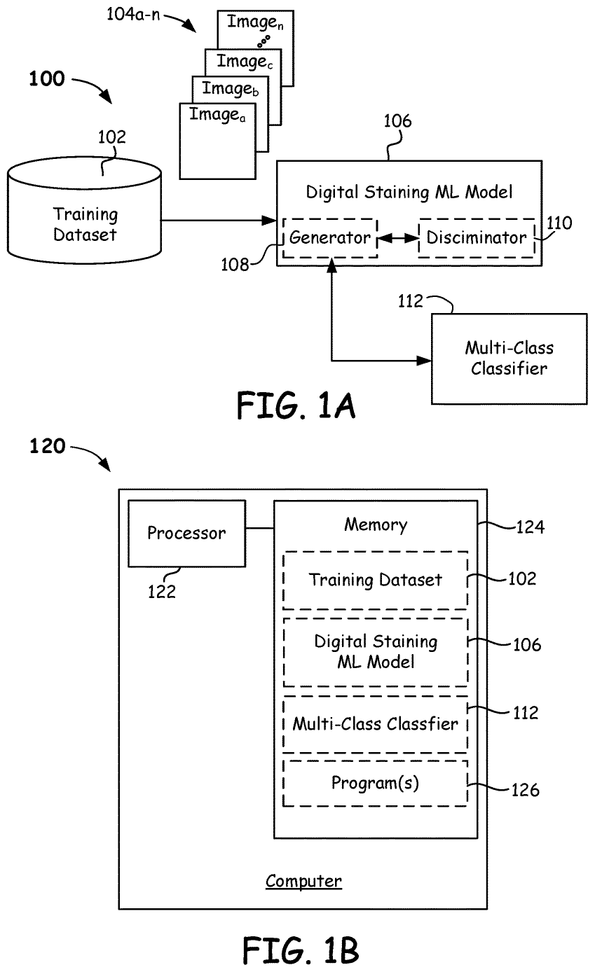

These and other embodiments provided herein are described below with reference to FIGS. 1A-4.

MSE is described, for example, in Wang, Z., Bovik, A. C., “Mean Squared Error: Love it or Leave it? A New Look at Signal Fidelity Measures,” IEEE Signal Processing Magazine, 26(1), 98-117(2009). SSIM is described, for example, in Wang, Z., Bovik, A. C., Sheikh, H. R., Simoncelli, E. P., “Image Quality Assessment: From Error Visibility to Structural Similarity,” IEEE Transactions on Image Processing 13(4), 600-612(2004). LPIPS is described, for example, in Zhang, R., Isola, P., Efros, A. A., Shechtman, E., Wang, O., “The Unreasonable Effectiveness of Deep Features as a Perceptual Metric,” Proceedings of the IEEE Conference on Computer Vision and Pattern Recognition, pp. 586-595 (2018).

FIG. 1A illustrates an example flow diagram 100 of a method of classifying components of a blood sample in accordance with embodiments provided herein. With reference to FIG. 1A, and as described in further detail below, the method of flow diagram 100 includes obtaining a training dataset 102 of images of blood samples (e.g., unstained and chemically stained peripheral blood smear images 104a-n such as differential-interference-contrast images or another image type). The training dataset 102 is then employed to train a machine-learning (ML) model 106 to digitally stain unstained images of blood samples. For example, in some embodiments, the ML model 106 may include a generative adversarial network (GAN) which includes a generator 108 and discriminator 110 trained on both unstained and chemically stained images as described further below. Once trained, the generator 108 may be employed to generate digitally stained images from original, unstained images.

In accordance with flow diagram 100, a multi-class classifier 112 may employ one or more intermediate features (e.g., feature vectors from generator 108) from the digital staining pipeline of digital staining model 106 during classification of components of a blood sample (e.g., properties of red or white blood cells). As described further below, in some embodiments, use of these intermediate features may improve classification by multi-class classifier 112. Additionally, classification by multi-class classifier 112 (e.g., during training) may improve digital staining performed by digital staining model 106.

FIG. 1B illustrates an example computer 120 in which the method of FIG. 1A may be implemented in accordance with one or more embodiments. With reference to FIG. 1B, computer 120 includes a processor 122 coupled to a memory 124. Memory 124 may include training dataset 102 (with images 104a-n), digital staining ML model 106, and multi-class classifier 112. Memory 124 may also include one or more programs 126 for carrying out the methods described herein when executed by processor 122, such as training digital staining ML model 106 and multi-class classifier 112 based on training dataset 102, employed trained digital staining ML model 106 to generate digitally stained images from unstained images, employing multi-class classifier 112 to classify images using one or more intermediate features from digital staining ML model 106, etc. Memory 124 may include multiple memory units and/or types of memory. In some embodiments, all or a portion of memory 124 may be external to and/or remote from computer 120. Additionally, in some embodiments, multiple processors may be employed.

As described previously, blood analysis is one of the most common prerequisites of the diagnosing process. A standard hematological test includes a complete blood count which measures the numbers of erythrocytes (red blood cells (RBCs)), leukocytes (white blood cells (WBCs)), platelets, hemoglobin concentration, and hematocrit. A standard hematological test outputs parameters such as average size and hemoglobin concentration per erythrocyte. Also, leukocytes are differentiated into their subcategories to support a physician's understanding of the sample.

Several features of a blood sample may be used to determine the class of a blood cell (e.g., healthy versus pathological) including size, shape, hemoglobin distribution, inclusions, granules, morphology, etc. Such features are generally determined by capturing an image of a peripheral blood smear magnified by a microscope and examining the image.

Not all the features necessary for classifying a pathological erythrocyte may be present in an unstained image. For this reason, blood samples may be chemically stained. For example, dots pointing to basophilic stippling may not be visible in an unstained image but clearly visible in a chemically stained image. On the other hand, in a healthy sample, the nucleus and granulation in the cytoplasm of an eosinophil leukocyte may be visible on chemically stained samples but not recognizable on an unstained pathological myelocyte. Hematologists typically recognize these features on stained images, requiring use of time-consuming and costly chemical staining to arrive at a diagnosis.

In accordance with embodiments provided herein, sample staining is treated as an image-to-image translation task in which deep learning allows replacement of chemical staining with digital staining. This approach significantly reduces laboratory costs associated with chemical dies, time, and waste management. By combining a neural network designed for artificial staining with a classifier, in some embodiments, a complete blood count and the labeling of pathological cells may be achieved.

As described further below, with the help of an auxiliary classifier, additional feature information from a digital staining pipeline may increase the classifier's performance. In some embodiments, a paired dataset is provided so that an exact representation of the blood cells in both domains is available. Since such datasets are rarely available, there has been limited focus on the supervised setting of image-to-image translation and even less effort to combine it with an auxiliary classification task. Embodiments provided herein demonstrate a relationship between classification and supervised image-to-image translation of hematological images.

The present disclosure focuses on two questions: whether all the features necessary for classification are present on unstained images; and whether classification influences digital staining and vice versa.

As mentioned before, the classification of unstained blood cells is a complex task because many features are only visible on stained cells. In some embodiments provided herein, by extracting features from a digital staining pipeline, a classifier may have more information about each cell, which may increase model performance. Further, in some embodiments, by integrating a classifier into the digital staining pipeline, ML models used for digital staining and classification may achieve high classification metrics and generate accurate digitally stained images from unstained ones.

By focusing on the improvement of the classification of unstained blood cells, embodiments provided herein introduce a supervised image-to-image translation network, where features from an ML model (e.g., a GAN generator) provide auxiliary information to a classifier to be able to predict the correct classes of unstained blood cells.

In some embodiments, the novel image translation approaches provided herein are based on generative adversarial networks (GANs), which include two neural networks: the generator, which is responsible for the translation of a random vector to a chosen distribution, and the discriminator, which is trained to distinguish between generated and real samples (e.g., images) from the same distribution. In conditional GANs, the generated output is conditioned on class values. For example, the ML model described in Isola, P., Zhu, J. Y., Zhou, T., Efros, A. A., “Image-to-Image Translation with Conditional Adversarial Networks,” Proceedings of the IEEE Conference on Computer Vision and Pattern Recognition, pp. 1125-1134 (2017) (hereinafter “Isola et al.”) and an improved variant described in Wang, T. C., Liu, M. Y., Zhu, J. Y., Tao, A., Kautz, J., Catanzaro, B., “High Resolution Image Synthesis and Semantic Manipulation with Conditional Gans,” Proceedings of the IEEE Conference on Computer Vision and Pattern Recognition, pp. 8798-8807 (2018) (hereinafter, “Wang et al.”), are based on a conditional GAN architecture, and can synthesize high-resolution images from semantic label maps.

In accordance with embodiments provided herein, for a digital staining task, class labels are fed into the digital staining pipeline such that class information has an influence on the generated image. In some embodiments, label information is not known beforehand but is predicted after (or in parallel with) image generation. As described below, class information may improve the artificial staining of an image (e.g., by a generator of a conditional GAN) even if the class information is initially unknown (e.g., during testing).

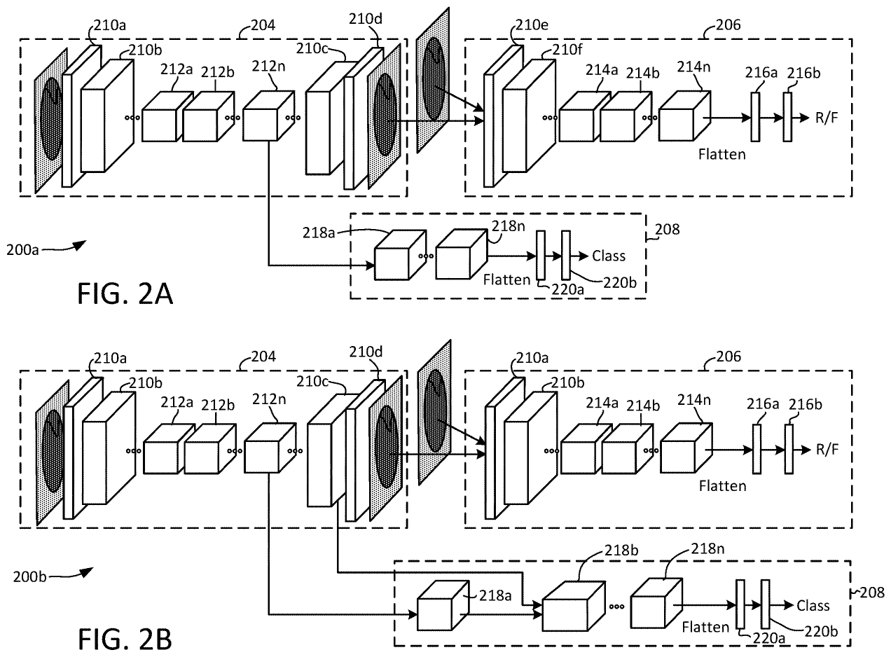

In some embodiments, a GAN is provided having a generator and a discriminator wherein the classifier is integrated into the generator but not into the discriminator. For example, FIGS. 2A and 2B illustrate example embodiments of a first digital staining and classification system 200a (FIG. 2A) and a second digital staining and classification system 200b (FIG. 2B) each having a GAN generator 204, a GAN discriminator 206, and a multi-class classifier 208 in accordance with embodiments provided herein. Information generated during digital staining of images by generator 204 may be provided to multi-class classifier 208 as described below.

With reference to FIGS. 2A and 2B, in some embodiments, the generator 204 may include convolutional, instance normalization, and activation function (e.g., ReLU) layers 210a, 210b, 210c and 210d (e.g., each layer 210a-210d may include a convolutional layer, an instance normalization layer an and activation function layer) and residual blocks 212a-212n. Similarly, discriminator 206 may include convolutional, instance normalization, and activation function layers 210e and 210f, residual blocks 214a-n, etc. One or more flattening layers and a fully connected layer (shown by layers 216a and 216b) may be employed to make a prediction of whether an image input to the discriminator 206 is real or fake (R/F). Other numbers, types, and/or arrangements of layers may be employed within the generator 204 and/or discriminator 206.

In one or more embodiments, the classifier 208 may include an input layer 218a, and various hidden layers 218b-n, one or more flattening layers and a fully connected layer (shown by layers 220a and 220b) may be employed to indicate a class indication and/or class probabilities. Other numbers, types, and/or arrangements of layers may be employed within the classifier 208.

Any suitable GAN, GAN generator, GAN discriminator, and/or classifier architectures may be employed. In one or more embodiments, the generator 204 may include one or more of convolutional layers, transposed convolutional layers, batch normalization layers, activation function layers (e.g., ReLU or leaky ReLU activation functions), fully connected layers, and/or the like. In some embodiments, the discriminator 206 may be formed from a neural network which includes one or more of convolutional layers, batch normalization layers, activation function layers (e.g., ReLU or leaky ReLU activation functions), fully connected layers, and/or the like.

In some embodiments, the multi-class classifier may be formed from a neural network having an input layer, hidden layers, and an output layer. Example neural networks include convolutional neural networks, recurrent neural networks, etc. The input layer receives input from the generator (e.g., one or more intermediate features such as one or more feature vectors as described above) and passes the input to the hidden layers. The hidden layers may employ activation functions, such as sigmoid or ReLU functions, to translate the input of the classifier to the output classes of the classifier. The output layer may then output class information (e.g., probabilities for each class using a softmax layer in some embodiments).

In some embodiments, one or more known network architectures may be modified for use within classifier 208 such as ResNet (see He, K., X. Zhang, S. Ren, and J. Sun (2016), “Deep Residual Learning for Image Recognition,” Proceedings of the IEEE Conference on Computer Vision and Pattern Recognition, pp. 770-778), EfficientNet (see Tan, M. and Q. Le (2019), “Efficientnet: Rethinking Model Scaling for Convolutional Neural Networks,” International Conference on Machine Learning, PMLR, pp. 6105-6114), Visual Geometry Group (VGG) (see Simonyan, K. and A. Zisserman (2014), “Very Deep Convolutional Networks for Large-Scale Image Recognition,” arXiv preprint arXiv: 1409.1556), ConvNext (see Liu, Z., H. Mao, C.-Y. Wu, C. Feichtenhofer, T. Darrell, and S. Xie (2022), “A ConvNet for the 2020s,” Proceedings of the IEEE/CVE Conference on Computer Vision and Pattern Recognition (CVPR)), etc.

In a first embodiment, shown in FIG. 2A, the input of the classifier 208 is a first intermediate feature within the digital staining pipeline (e.g., a feature vector, such as a one dimensional or multi-dimensional vector). In some embodiments, the first intermediate feature may be from the beginning of the first decoder of the generator 204. For example, in some embodiments, the first intermediate feature may be from the last residual block 212n (e.g., the last layer of the bottleneck formed by the residual blocks 212a-212n). Other intermediate features may be used. In this manner, the generator 204 may extract relevant class information stored in the bottleneck layers of the generator 204 which may help the classifier 208. Further, the back propagation of the gradients from the classifier 208 may help improve image generation performed by the generator 204 (as described further below).

In a second embodiment, shown in FIG. 2B, the classifier 208 may employ both the first intermediate feature and a second, additional intermediate feature (e.g., a feature vector). In some embodiments, the second intermediate feature may be from one or more up-sampling layers of the generator 204. For example, in some embodiments, a first layer of a decoder of the generator 204 (e.g., layer 210c in FIG. 1B) may provide the second intermediate feature information to the classifier 208.

In one or more embodiments, the first and/or second intermediate features may be concatenated with hidden vectors of the classifier 208 having the same height and width values (e.g., stacking the intermediate feature values together in a layer of the classifier such as layer 218b in FIG. 2B). In this manner, the classifier 208 may employ features from within the digital staining pipeline of generator 204 which are relevant to the image-to-image translation and which may contain more information than the unstained image. These intermediate features are typically not directly visible and/or accessible to a user (although they influence the final digitally stained image).

As stated, in the embodiment of FIG. 2B, the first intermediate feature is fed from the last residual block 212n of the bottleneck of the generator 204 to the input layer 218a of the classifier 208 and the second intermediate feature is fed from the first layer of the decoder (e.g., layer 210c) of the generator 204 to a hidden layer 218b of the classifier 208 (e.g., such as a convolution layer followed by an activation function).

The embodiment of FIG. 2A is referred to herein as “CM_1F” (current model one with one intermediate feature) and the embodiment of FIG. 2B is referred to herein as “CM_2F” (current model two with two intermediate features). In both embodiments, the ML models employed for digital staining (e.g., the generator 204 and discriminator 206) may be trained employing any suitable loss terms (e.g., to minimize generator and discriminator losses). For example, in some embodiments, the loss terms employed in Wang et al. may be employed.

In accordance with one or more embodiments provided herein, an improved generator loss, L_{G}, is described as follows:

$${L}_{G} = {L}_{G \_ GAN} + {L}_{G \_ GAN \_ FEAT} + {L}_{G \_ VGG} + {L}_{CE}$$

where L_{G_GAN} is the probability that a generated image is real (e.g., fake passability loss), L_{C_CAN_FEAT} refers to the GAN feature matching loss, L_{G_vGG} refers to the V_{GG} feature matching loss, and L_{CE} refers to an additional classification loss term (e.g., a cross-entropy (CE) loss function depending on the component of the blood being classified as described below).

In some embodiments, because leukocytes (white blood cells (WBCs)) are labeled with only one label from 7 or 14 classes, the classification loss L_{CE} may be a cross-entropy loss (L_{CE_WBC}). For erythrocytes (red blood cells (RBCs)), the classifier implemented for the erythrocyte dataset may be more complex since the cells have corresponding labels belonging to four categories (e.g., size, shape, hemoglobin distribution, and inclusion). For the first three categories, separate cross-entropy loss may be applied and lastly a binary-cross-entropy loss may be applied to the inclusion category. These losses are combined together into one final classification loss term (L_{CE_RBC}=L_{CE_SIZE}+L_{CE_SHAPE}+L_{CE_HEMO}+LB_{CE_INCL}). In some embodiments, through use of the above-described loss terms, training of the network is stable and no regularizer is implemented. In other embodiments, one or more regularization terms may be employed.

In some embodiments, whether features needed for successful classification are present in unstained images is examined by training a set of neural network classifiers (e.g. a plurality of multi-class classifiers 208) and analyzing their performance in different configurations. To determine how image generation influences classification, and vice versa, a multi-task model is employed. Given a dataset, which contains both unstained and chemically stained images of blood cells with corresponding classes, an objective of the present disclosure is to classify the unstained images. In some embodiments, in order to support a classical classifier architecture, a neural network is provided which joins a generator and classifier that share features and which are optimized jointly. As described further below, these embodiments demonstrate that a classifier module may be augmented to output multiple characteristics of given cells.

As stated, in some embodiments, a GAN generator may include a combination of convolutional, instance normalization and ReLU layers and residual blocks. Convolutional, instance normalization and ReLU layers may be used to perform style transfer (e.g., creating digitally stained images from unstained images).

In some embodiments, architectures similar to the generator and/or discriminator described in Wang et al. may be employed. In one or more embodiments, the classifier may be based on EfficientNet and/or ConvNext architectures.

To evaluate embodiments provided herein, a set of experiments was performed on two different datasets. Deep learning models were trained using Python 3.7.13, PyTorch 1.12.0, and Cudatoolkit 11.3.1 on a Titan X GPU with 12 GB RAM available from Nvidia Corporation of Santa Clara, CA. Other software packages and/or computer components may be employed.

Private leukocytes and erythrocyte datasets including images acquired by two different scanners, from 175 and 43 patients, respectively, were provided and annotated by two hematologists. Tables 1 (A)-1 (E) illustrate label distribution in the leukocyte and erythrocyte (category-wise) dataset. For training image-to-image translation networks, a train-test split was used. While training the classification networks an additionally separated validation set was employed. The erythrocyte images had a size of 120×120 pixels, while the leukocytes had a size of 360×360 pixels, which were cut to 240×240 pixels and resized to 120×120 before entering the networks.

To classify leukocytes, two datasets were created from the previously introduced dataset: first, all 14 classes were included (see both Table 1 (A) and Table 1 (B)); and second, the five normal leukocyte types (basophils (BA), eosinophils (EO), segmented neutrophil granulocyte (SNE), monocytes (MO), and lymphocytes (LY)), plus artifacts (ART) and smudges (SMU) only were used (see Table 1 (A)).

For the classification of erythrocytes, labels corresponding to four categories were available: inclusion, shape, size, and hemoglobin distribution as indicated in Table 1 (C), Table 1 (D), Table 1 (E), and Table (1F), respectively. It was also observed how the categories influence each other since the labels of the categories are dependent and auxiliary information coming from the different categories may increase the performance of the classifier.

TABLE 1(A)
Healthy leukocytes

| | Healthy Leukocytes | | | | | | |
|---|---|---|---|---|---|---|---|
| | BA | EO | SNE | MO | LY | ART | SMU |
| Train | 1287 | 3323 | 88897 | 9792 | 33716 | 1078 | 10164 |
| Val | 210 | 897 | 16541 | 1721 | 6632 | 141 | 1973 |
| Test | 259 | 665 | 13085 | 1052 | 4409 | 163 | 1484 |

TABLE 1 (B)
Pathological leukocytes

| | Pathological Leukocytes | | | | | | |
|---|---|---|---|---|---|---|---|
| | VLY | BL | NRBC | MMY | MY | PMY | PC |
| Train | 7830 | 5968 | 1072 | 900 | 907 | 292 | 13 |
| Val | 1753 | 65 | 98 | 33 | 23 | 17 | 3 |
| Test | 1443 | 597 | 541 | 196 | 117 | 39 | 5 |

TABLE 1 (C)
Inclusion category for erythrocytes

| | Inclusion Category | | | | | |
|---|---|---|---|---|---|---|
| | ACAN | BITE | ECHI | ELLI | HELM | NONE |
| Train | 180 | 64 | 626 | 171 | 386 | 8033 |
| Val | 65 | 4 | 375 | 67 | 11 | 2186 |
| Test | 166 | 41 | 100 | 56 | 91 | 1043 |

TABLE 1(D)
Shape category for erythrocytes

| | Shape Category | | | | |
|---|---|---|---|---|---|
| | OVAL | SCHI | SICK | SPHE | TEAR |
| Train | 748 | 422 | 38 | 100 | 769 |
| Val | 236 | 37 | 0 | 2 | 84 |
| Test | 69 | 241 | 1 | 11 | 57 |

TABLE 1(E)
Size category for erythrocytes

| | Size Category | | |
|---|---|---|---|
| | NORM | MACR | MICR |
| Train | 9463 | 513 | 1561 |
| Val | 2182 | 98 | 787 |
| Test | 1582 | 157 | 137 |

TABLE 1(F)
Hemoglobin distribution category for
erythrocytes

| | Hemoglobin Distribution | | | | |
|---|---|---|---|---|---|
| | Category | | | | |
| | HYPO | HYPR | NONE | STOM | TARG |
| Train | 1145 | 611 | 9050 | 207 | 524 |
| Val | 629 | 74 | 2263 | 26 | 75 |
| Test | 148 | 136 | 1472 | 28 | 92 |

Classifiers were compared with a different number of heads: firstly, one-headed (multi-output) classifiers were trained for each category separately. Secondly, a four-headed classifier was trained including all categories. The four-headed classifier was expected to outperform the single-headed ones, since in this case, the classifier has an overall look at the cells, and can recognize the possible class pairs of different categories. In the inclusion category the labels were highly unbalanced (see Table 1 (C)), thus embodiments provided herein may include the use of two labels for the classification task: normal and pathological, which facilitates the classification. During the experiments, no balancing techniques were used. Data augmentations, like rotating or flipping were not applied, since these augmented images would not correspond to real data in the test set. Oversampling of the underrepresented classes was not applied, since oversampling a rare cell type of one category may cause a major imbalance in the other category.

In the first series of experiments, it was observed how staining influences the performance of the classifiers. Chemical staining is used worldwide for arriving at a diagnosis since more information is available on stained images, thus one may expect better performance of classifiers trained and evaluated on stained cells. Embodiments of the present disclosure use three different baselines with pre-trained weights for the classification models: EfficientNet (69M parameters), VGG 19 (136M parameters), and ConvNext (201M parameters), thus the size of the models are in the same order of magnitude with the digital staining pipelines. The leukocyte classifiers were trained for 45 epochs, and the 1-headed and 4-headed erythrocyte classifiers were trained for 35 and 75 epochs, respectively, to stop the models from overfitting. All digital staining models were trained for 100 epochs.

To examine the performance of the ML models described herein, four ML models (CM_1F, CM_2F, PM_1, and PM_2) were compared:
(1) CM_1F: the ML model in which the classifier 208 (FIG. 2A) is fed one intermediate feature (current model with one feature or “CM_1F”);

(2) CM_2F: the ML model in which the classifier 208 (FIG. 2B) is fed two intermediate features from the generator 204 (current model with two intermediate features or “CM_2F”);

(3) PM_1: the ML model described in Wang et al. (referred to as prior model one or “PM_1”); and

(4) PM_2: the ML model described in Odena, A., Olah, C., Shlens, J., “Conditional Image Synthesis with Auxiliary Classifier Gans,” International Conference on Machine Learning. pp. 2642-2651. PMLR (2017) (referred to as prior model two or “PM_2”).

In Tables 2(A) and 2(B), the metrics of the best-performing models (PM_2, CM_1F, and CM_2F) were chosen and the accuracy and F1 score with “macro” setting (which calculates the F1 score for each label, and outputs the unweighted mean) of the multi-class classifiers on stained and unstained images are compared. The results are in line with expectations: the gap between the stained and unstained images is visible in all models.

TABLE 2 (A)
Classification metrics of the WBC
digital staining pipeline for 1-headed multi-class classifier.

| | Multi-Class (1-headed) | | | | | | |
|---|---|---|---|---|---|---|---|
| | | | Stain. | Unst. | PM_2 | CM_1F | CM_2F |
| WBC | 14 cl | Acc. | 94.18 | 90.52 | 88.61 | 91.67 | 91.24 |
| | | F1 | 81.87 | 66.61 | 47.8 | 68.87 | 65.29 |
| | 7 cl | Acc. | 98.42 | 97.06 | 97.19 | 97.78 | 97.29 |
| | | F1 | 93.18 | 88.59 | 87.62 | 90.46 | 89.82 |
| RBC | Size | Acc. | 83.37 | 82.14 | 82.24 | 84.38 | 84.65 |
| | | F1 | 70.69 | 68.14 | 69.01 | 70.13 | 71.19 |
| | Shape | Acc. | 82.52 | 80.7 | 59.35 | 74.79 | 71.7 |
| | | F1 | 62.29 | 59.95 | 28.95 | 47.41 | 42.93 |
| | Hemo. | Acc. | 87.58 | 85.34 | 84.67 | 87.47 | 85.87 |
| | | F1 | 75.7 | 70.02 | 58.59 | 69.76 | 61.27 |
| | Incl. | Acc. | 97.92 | 89.61 | 57.37 | 87.82 | 87.93 |
| | | F1 | 94.05 | 71.65 | 41.64 | 63.12 | 64.02 |

TABLE 2 (B)
Classification metrics of the WBC
digital staining pipeline for 4-headed multi-output
classifier.

| | Multi-Output (4-headed) | | | | | | |
|---|---|---|---|---|---|---|---|
| | | | Stain. | Unst. | PM_2 | CM_1F | CM_2F |
| WBC | 14 cl | Acc. | — | — | — | — | — |
| | | F1 | — | — | — | — | — |
| | 7 cl | Acc. | — | — | — | — | — |
| | | F1 | — | — | — | — | — |
| RBC | Size | Acc. | 82.2 | 81.61 | 82.8 | 80.01 | 85.45 |
| | | F1 | 69.8 | 69.21 | 68 | 65.12 | 68.25 |
| | Shape | Acc. | 81.77 | 80.97 | 55.02 | 70.63 | 69.4 |
| | | F1 | 60.6 | 59.1 | 26.73 | 41.46 | 37.66 |
| | Hemo. | Acc. | 87.95 | 85.39 | 81.41 | 82.52 | 85.71 |
| | | F1 | 77.39 | 70.59 | 54.91 | 64 | 63.48 |
| | Incl. | Acc. | 96.54 | 89.66 | 41.45 | 83.12 | 88.68 |
| | | F1 | 90.46 | 72.12 | 35.28 | 61.13 | 64.97 |

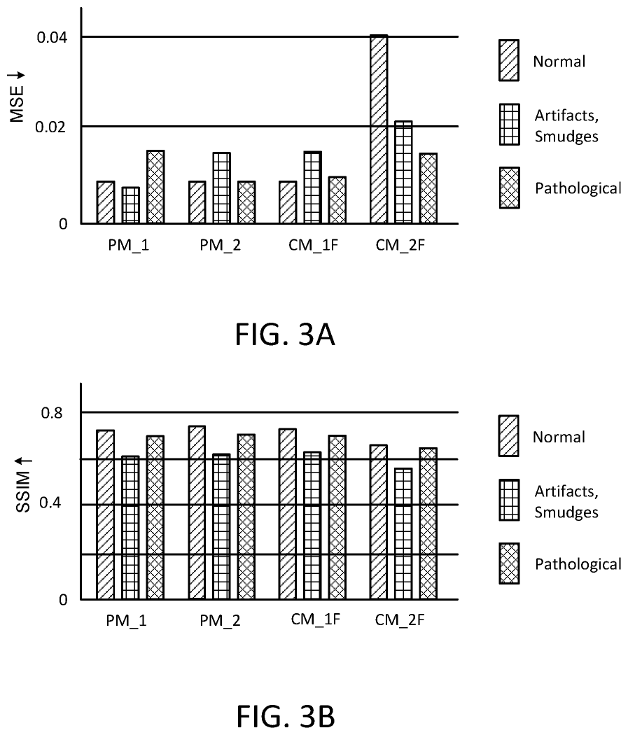

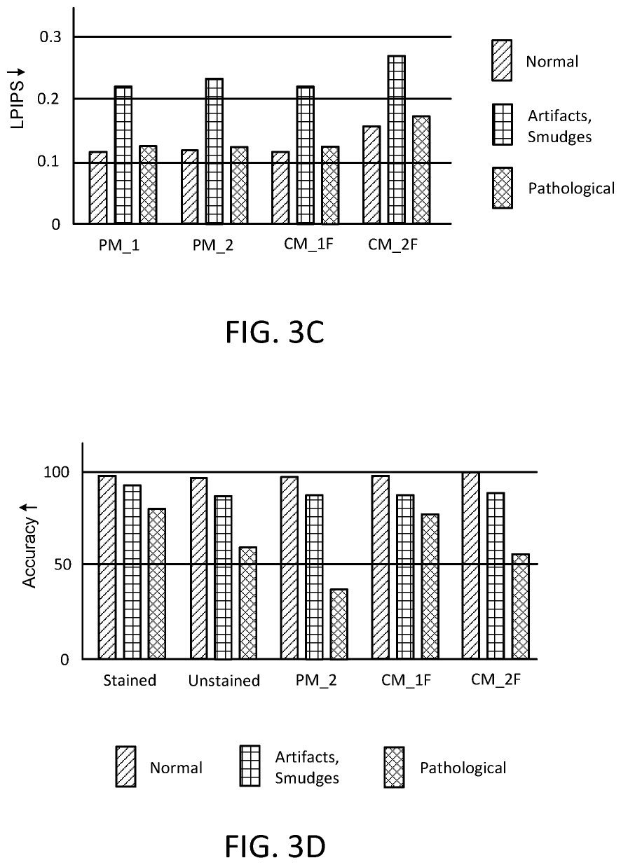

FIGS. 3A-3C illustrate category-wise digital staining metrics for leukocytes for four models (PM_1, PM_2, CM_1F, and CM_2F) in accordance with embodiments provided herein. Since artifacts and smudges have diverse appearances, they are handled separately from the blood cells. FIG. 3D illustrates accuracy in image quality results for leukocytes between stained, unstained, and the three best performing models (PM_2, CM_1F, and CM_2F) in accordance with embodiments provided herein. In general, it was observed that all models perform better on normal cells.

It can be observed in FIG. 3D that the classification accuracy difference between stained and unstained healthy leukocytes is 18 and is 20% for the pathological cells. In the case of the RBC models, the healthy-pathological separation of cells cannot provide relevant information since only one healthy label is present in each category, and if a cell represents the healthy class in one category, the remaining labels corresponding to the other categories could be pathological. Overall, the metrics of the models trained on the leukocyte dataset are more accurate, which is caused by its stable dataset compared to the erythrocytes' unbalanced and smaller dataset. In some embodiments, it is expected that the size and shape would be the best performing categories since for these two categories all necessary features are present on the unstained images. Since the shape category has 11 classes and some classes have similar appearances, such as ovalocytes and elliptocytes, the classifier did not correctly classify the underrepresented pathological classes.

Embodiments of the models provided herein were compared to two prior models as described below with reference to Tables 3 (A)-3 (F). As stated, the first prior model is referred to as PM_1 and the second prior model is referred to as PM_2. In the second prior model (PM_2), an auxiliary classifier was integrated into the discriminator of the first prior model (PM_1). The first model of the present disclosure is referred to as CM_1F (current model with 1 intermediate feature) while the second model of the present disclosure is referred to as CM_2F (current model with 2 intermediate features).

By comparing the accuracy and F1 score values of the classifiers to the three multi-task learning models it is expected that the digital staining pipelines would outperform the classifiers trained on unstained images. This can be explained by the fact that the digital staining pipeline learns necessary features for the staining, and these features play a key role in the classification.

On the leukocyte dataset (see Tables 2(A) and 2(B)) an increase in the classification performance can be observed, where the models of the present disclosure outperform the classifiers trained on the unstained images. A more significant increase in the F1 score proves that the features from the generator can capture relevant properties of the pathological cells. Based on the detailed evaluation of leukocytes (FIGS. 3A-3D), it can be observed that the digital staining of pathological cells has worse image quality than normal cells, which implies there are missing key features from the pathological cells. On the other hand, as expected, none of these models outperform the classifiers trained on stained images.

On the erythrocyte dataset (see Table 2(A) and Table 2(B)), the proposed models of the present disclosure with multi-class classification in the size and hemoglobin distribution categories outperform the classifiers trained on unstained images, but the shape classifier has fallen behind with its similar classes. When the metrics of the 1-headed and 4-headed models are compared (Table 2(A) versus Table 2(B), only small oscillations can be observed, thus the classifiers could not learn the dependencies between the categories, which could be caused by the lacking data from the pathological classes.

With these results, it can be seen that through use of embodiments provided herein, the features in the unstained images are enough for the classification of normal cells (e.g., by using intermediate features extracted from the digital staining pipeline), but they lack details for the classification of pathological cells. The CM_1F feature vector extracted from the generator 204 of FIG. 2A (e.g., the single intermediate feature embodiment) performed the best on the dataset of the present disclosure. Further, placement of the classifier in the network is also relevant (e.g., integrating the classifier with the generator rather than the discriminator).

The above-introduced models were also evaluated in terms of the image quality compared to the chemically stained ground truth images. Embodiments of the present disclosure measure the image quality with MSE (Mean Square Error), SSIM (Structured Similarity Indexing Method), and LPIPS (Learned Perceptual Image Patch Similarity). Increased image quality is expected since the classifier can help the generator to find similarities in each class. As mentioned previously, the image quality metrics of multi-task learning models of the present disclosure (CM_1F and CM_2F) are compared to the prior models PM_1 and PM_2. The image quality metrics are shown in Tables 3(A)-3(F).

In the case of the leukocytes, the generated image qualities are in the same order of magnitude, and small oscillations can be observed. Only a slight improvement is observed in the first of the two models of the present disclosure. This result is promising because ground truth chemically stained images can be blurry and sometimes have slightly different tonicity. Thus beneficially, despite the fact that digitally stained images of the present disclosure are clear, the image quality metrics remain similar.

Overall, the embodiment of the present disclosure in which two intermediate features from the generator are employed (CM_2F as shown in FIG. 2B) has the least accurate generated images since this model has the most complex classifier, which takes computational capacity away from the generator. Therefore, the generator does not recognize the important features coming from the unstained images as well as the one intermediate feature model (CM_1F as shown in FIG. 2A).

Based on these results, a multi-task learning model in accordance with embodiments provided herein can increase the classification results and improve generated image quality.

TABLE 3 (A)
Image quality metrics of leukocyte
digital staining.

| | | | PM_1 | PM_2 | CM_1F | CM_2F |
|---|---|---|---|---|---|---|
| WBC | 14 | MSE ↓ | 0.009 | 0.0088 | 0.009 | 0.0139 |
| | cl | SSIM ↑ | 0.7325 | 0. 7404 | 0.7299 | 0.6603 |
| | | LPIPS ↓ | 0.1275 | 0.1267 | 0.123 | 0.1661 |
| | 7 | MSE ↓ | 0.01 | 0.0115 | 0.0094 | 0.0126 |
| | cl | SSIM ↑ | 0.7155 | 0.715 | 0.7264 | 0.68 |
| | | LPIPS ↓ | 0.1337 | 0.134 | 0.1258 | 0.1466 |

TABLE 3 (B)
Image quality metrics of erythrocyte
digital staining.

| | | | PM_1 | PM_2 | CM_1F | CM_2F |
|---|---|---|---|---|---|---|
| RBC | 1-h | MSE ↓ | 0.0058 | — | — | — |
| | | SSIM ↑ | 0.7358 | — | — | — |
| | | LPIPS ↓ | 0.1399 | — | — | — |
| | 4-h | MSE ↓ | 0.0058 | 0.0059 | 0.0608 | 0.0846 |
| | | SSIM ↑ | 0.7358 | 0.7466 | 0.2757 | 0.2594 |
| | | LPIPS ↓ | 0.1399 | 0.1823 | 0.1558 | 0.1605 |

TABLE 3 (C)
Image quality metrics of erythrocyte
digital staining for size.

| | | | SIZE | | | |
|---|---|---|---|---|---|---|
| | | | PM_1 | PM_2 | CM_1F | CM_2F |
| RBC | 1-h | MSE ↓ | — | 0.0062 | 0.0153 | 0.074 |
| | | SSIM ↑ | — | 0.7398 | 0.4064 | 0.1623 |
| | | LPIPS ↓ | — | 0.1831 | 0.1355 | 0.16 |
| | 4-h | MSE ↓ | — | — | — | — |
| | | SSIM ↑ | — | — | — | — |
| | | LPIPS ↓ | — | — | — | — |

TABLE 3 (D)
Image quality metrics of erythrocyte
digital staining for shape.

| | | | SHAPE | | | |
|---|---|---|---|---|---|---|
| | | | PM_1 | PM_2 | CM_1F | CM_2F |
| RBC | 1-h | MSE ↓ | — | 0.0063 | 0.0106 | 0.1207 |
| | | SSIM ↑ | — | 0.7432 | 0.5635 | 0.194 |
| | | LPIPS ↓ | — | 0.1871 | 0.1393 | 0.1773 |
| | 4-h | MSE ↓ | — | — | — | — |
| | | SSIM ↑ | — | — | — | — |
| | | LPIPS ↓ | — | — | — | — |

TABLE 3 (E)
Image quality metrics of erythrocyte
digital staining for hemoglobin distribution.

| | | | HEMO | | | | | |
|---|---|---|---|---|---|---|---|---|
| | | | PM_1 | PM_2 | CM_1F | CM_2F | PM_1 | PM_2 |
| RBC | 1-h | MSE ↓ | — | | 0.0057 | 0.0248 | | 0.0428 |
| | | SSIM ↑ | — | | 0.751 | 0.4847 | | 0.4707 |
| | | LPIPS ↓ | — | | 0.1835 | 0.1376 | | 0.1616 |
| | 4-h | MSE ↓ | — | | — | — | | — |
| | | SSIM ↑ | — | | — | — | | — |
| | | LPIPS ↓ | — | | — | — | | — |

TABLE 3 (F)
Image quality metrics of erythrocyte
digital staining for inclusions.

| | | | INCL | | | |
|---|---|---|---|---|---|---|
| | | | PM_1 | PM_2 | CM_1F | CM_2F |
| RBC | 1-h | MSE ↓ | — | 0.0058 | 0.0568 | 0.0926 |
| | | SSIM ↑ | — | 0.7484 | 0.2454 | 0.3798 |
| | | LPIPS ↓ | — | 0.1836 | 0.1505 | 0.1714 |
| | 4-h | MSE ↓ | — | — | — | — |
| | | SSIM ↑ | — | — | — | — |
| | | LPIPS ↓ | — | — | — | — |

Based on the class-wise evaluations, in some embodiments, networks provided herein work accurately on normal-cells. The necessary features for the classification are missing for visual inspection on the unstained images, but network embodiments provided herein, such as the embodiments of FIGS. 2A and 2B, may recover auxiliary information from the stained images, which increased the classification performance. Based on this, in some embodiments, the methods provided herein may be used in clinical settings such as performing a complete blood count. A different image modality, which captures more details about unstained cells, may allow use of the ML networks provided herein in a more complex clinical setting such as determining the pathology of a patient. For example, other methods may allow the capture and extraction of features of unstained images with the goal of determining a diagnosis of a patient as accurately as using chemically stained images with the networks described herein.

As described above, in one or more embodiments, an ML model for the simultaneous classification and digital staining of erythrocyte and leukocyte datasets is shown to achieve higher classification performance on unstained images. The ML model produces high-quality and accurate digitally stained images for normal cells on both datasets. The ML model may outperform other classifiers and reduce the classification performance gap between stained and unstained images.

Embodiments provided herein demonstrate how multi-task learning influences the performance of classification and digital staining. Further, the integration place of the classifier may play a significant role in performance. In some embodiments, the most efficient framework is the model of the present disclosure in which the input of the classifier is a feature vector from the end of the bottleneck of the GAN generator (e.g., FIG. 2A). It is further observed in some embodiments that the image-to-image translation pipeline increases classification metrics, while improving the generated image quality. In one or more embodiments, employing the ML models described herein may eliminate the need for chemical staining in a healthy sample.

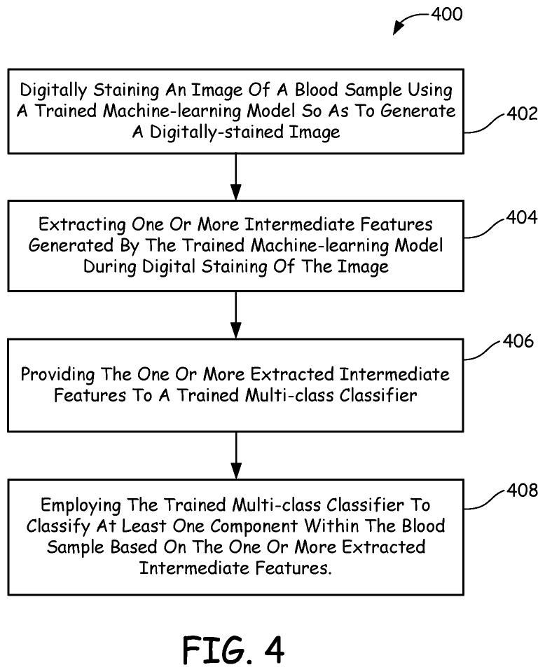

FIG. 4 illustrates a flowchart of a method 400 of classifying components of a blood sample in accordance with one or more embodiments. With reference to FIG. 4, in block 402, method 400 includes digitally staining an image of a blood sample using a trained machine-learning model so as to generate a digitally-stained image. For example, in some embodiments, an unstained image may be input to an ML-model (e.g., generator 204) which has been trained to digitally stain the image.

During the digital staining process, intermediate features are generated within the various layers of the ML model (e.g., convolutional layers, residual blocks, activation function layers, or the like). In block 404, method 400 includes extracting one or more intermediate features generated by the trained machine-learning model during digital staining of the image. In some embodiments, the one or more intermediate features may be feature vectors extracted from a bottle neck layer (e.g., a residual block) and/or a decoder layer of a GAN generator (e.g., generator 204 of FIGS. 2A or 2B).

In block 406, method 400 includes providing the one or more extracted intermediate features to a trained multi-class classifier. As depicted in FIGS. 2A and 2B, in one or more embodiments, intermediate features of the digital staining pipeline (e.g., classifier 208) may be fed to one or more layers of classifier 208 (e.g., an input layer, a deeper and/or hidden layer, etc.). Thereafter, in block 408, method 400 includes employing the trained multi-class classifier to classify at least one component within the blood sample based on the one or more extracted intermediate features.

All publications and patents cited in this disclosure (including those listed above) are incorporated by reference herein in their entirety for all purposes as if each individual publication or patent was specifically and individually indicated to be incorporated by reference.

The foregoing description discloses only example embodiments of the invention. Modifications of the above disclosed apparatus and methods which fall within the scope of the invention will be readily apparent to those of ordinary skill in the art.

Accordingly, while the present invention has been disclosed in connection with example embodiments thereof, it should be understood that other embodiments may fall within the spirit and scope of the invention, as defined by the following claims.

### ILLUSTRATIVE EMBODIMENTS

The following provides a non-limiting list of illustrative embodiments of this disclosure:

Example Embodiment 1. A method of classifying components of a blood sample comprising:
digitally staining an image of a blood sample using a trained machine-learning model so as to generate a digitally-stained image;
extracting one or more intermediate features generated by the trained machine-learning model during digital staining of the image;
providing the one or more extracted intermediate features to a trained multi-class classifier; and
employing the trained multi-class classifier to classify at least one component within the blood sample based on the one or more extracted intermediate features.

Example Embodiment 2. The method of any one of the preceding Example Embodiments wherein the image comprises a differential-interference-contrast image.

Example Embodiment 3. The method of any one of the preceding Example Embodiments wherein the trained machine-learning model comprises a trained generator of a generative adversarial network.

Example Embodiment 4. The method of any one of the preceding Example Embodiments wherein the one or more intermediate features generated by the trained generator comprise a feature vector.

Example Embodiment 5. The method of any one of the preceding Example Embodiments wherein the feature vector is extracted from a last layer of a bottleneck of the generator.

Example Embodiment 6. The method of any one of the preceding Example Embodiments further comprising adding the feature vector to the multi-class classifier.

Example Embodiment 7. The method of any one of the preceding Example Embodiments wherein adding the feature vector comprises concatenating the feature vector from the trained generator with a vector of the multi-class classifier having a same height value and a same width value.

Example Embodiment 8. The method of any one of the preceding Example Embodiments wherein the one or more extracted intermediate features are not visible in the digitally-stained image.

Example Embodiment 9. The method of any one of the preceding Example Embodiments wherein employing the trained multi-class classifier to classify at least one component within the blood sample based on the one or more extracted intermediate features comprises classifying at least one of a red blood cell and a white blood cell.

Example Embodiment 10. The method of any one of the preceding Example Embodiments wherein classifying at least one of a red blood cell and a white blood cell comprises classifying at least one of size, shape, hemoglobin distribution, inclusion, granules, and morphology.

Example Embodiment 11. A machine-learning-based digital staining and classification system comprising:
a processor;
a memory coupled to the processor, the memory including a trained machine-learning (ML) model and a multi-class classifier coupled to the trained ML model; and
computer program instructions stored in the memory that, when executed by the processor, cause the processor to:
   digitally stain an image of a blood sample using the trained ML model so as to generate a digitally-stained image;
   extract one or more intermediate features generated by the trained machine-learning model during digital staining of the image;
   provide the one or more extracted intermediate features to the trained multi-class classifier; and
   employ the trained multi-class classifier to classify at least one component within the blood sample based on the one or more extracted intermediate features.

Example Embodiment 12. The system of any one of the preceding Example Embodiments wherein the image comprises a differential-interference-contrast image.

Example Embodiment 13. The system of any one of the preceding Example Embodiments wherein the trained machine-learning model comprises a trained generator of a generative adversarial network.

Example Embodiment 14. The system of any one of the preceding Example Embodiments wherein the one or more intermediate features generated by the trained generator comprise a feature vector.

Example Embodiment 15. The system of any one of the preceding Example Embodiments wherein the feature vector is extracted from a last layer of a bottleneck of the trained generator.

Example Embodiment 16. The system of any one of the preceding Example Embodiments further comprising computer program instructions stored in the memory that, when executed by the processor, cause the processor to add the feature vector to the multi-class classifier.

Example Embodiment 17. The system of any one of the preceding Example Embodiments further comprising computer program instructions stored in the memory that, when executed by the processor, cause the processor to concatenate the feature vector from the trained generator with a vector of the multi-class classifier having a same height value and a same width value.

Example Embodiment 18. The system of any one of the preceding Example Embodiments wherein the one or more extracted intermediate features are not visible in the digitally-stained image.

Example Embodiment 19. The system of any one of the preceding Example Embodiments further comprising computer program instructions stored in the memory that, when executed by the processor, cause the processor to classify at least one of a red blood cell and a white blood cell using the multi-class classifier.

Example Embodiment 20. The system of any one of the preceding Example Embodiments further comprising computer program instructions stored in the memory that, when executed by the processor, cause the processor to classify at least one of size, shape, hemoglobin distribution, inclusion, granules, and morphology using the multi-class classifier.

What is claimed is:

1. A method of classifying components of a blood sample comprising:
digitally staining an image of a blood sample using a trained machine-learning model so as to generate a digitally-stained image;
extracting one or more intermediate features generated by the trained machine-learning model during digital staining of the image;
providing the one or more extracted intermediate features to a trained multi-class classifier; and
employing the trained multi-class classifier to classify at least one component within the blood sample based on the one or more extracted intermediate features.

2. The method of claim 1 wherein the image comprises a differential-interference-contrast image.

3. The method of claim 1 wherein the trained machine-learning model comprises a trained generator of a generative adversarial network.

4. The method of claim 3 wherein the one or more intermediate features generated by the trained generator comprise a feature vector.

5. The method of claim 4 wherein the feature vector is extracted from a last layer of a bottleneck of the generator.

6. The method of claim 4 further comprising adding the feature vector to the multi-class classifier.

7. The method of claim 6 wherein adding the feature vector comprises concatenating the feature vector from the trained generator with a vector of the multi-class classifier having a same height value and a same width value.

8. The method of claim 1 wherein the one or more extracted intermediate features are not visible in the digitally-stained image.

9. The method of claim 1 wherein employing the trained multi-class classifier to classify at least one component within the blood sample based on the one or more extracted intermediate features comprises classifying at least one of a red blood cell and a white blood cell.

10. The method of claim 9 wherein classifying at least one of a red blood cell and a white blood cell comprises classifying
at least one of size, shape, hemoglobin distribution, inclusion, granules, and morphology.

11. A machine-learning-based digital staining and classification system comprising:
a processor;
a memory coupled to the processor, the memory including a trained machine-learning (ML) model and a multi-class classifier coupled to the trained ML model; and
computer program instructions stored in the memory that, when executed by the processor, cause the processor to:
digitally stain an image of a blood sample using the trained ML model so as to generate a digitally-stained image;
extract one or more intermediate features generated by the trained machine-learning model during digital staining of the image;
provide the one or more extracted intermediate features to the trained multi-class classifier; and
employ the trained multi-class classifier to classify at least one component within the blood sample based on the one or more extracted intermediate features.

12. The system of claim 11 wherein the image comprises a differential-interference-contrast image.

13. The system of claim 11 wherein the trained machine-learning model comprises a trained generator of a generative adversarial network.

14. The system of claim 13 wherein the one or more intermediate features generated by the trained generator comprise a feature vector.

15. The system of claim 14 wherein the feature vector is extracted from a last layer of a bottleneck of the trained generator.

16. The system of claim 14 further comprising computer program instructions stored in the memory that, when executed by the processor, cause the processor to add the feature vector to the multi-class classifier.

17. The system of claim 16 further comprising computer program instructions stored in the memory that, when executed by the processor, cause the processor to concatenate the feature vector from the trained generator with a vector of the multi-class classifier having a same height value and a same width value.

18. The system of claim 11 wherein the one or more extracted intermediate features are not visible in the digitally-stained image.

19. The system of claim 11 further comprising computer program instructions stored in the memory that, when executed by the processor, cause the processor to classify at least one of a red blood cell and a white blood cell using the multi-class classifier.

20. The system of claim 19 further comprising computer program instructions stored in the memory that, when executed by the processor, cause the processor to classify at least one of size, shape, hemoglobin distribution, inclusion, granules, and morphology using the multi-class classifier.
